(19) United States
(12) Patent Application Publication
(10) Pub. No.: US 2025/0203136 A1
(43) Pub. Date: Jun. 19, 2025

(54) SIGNAL TRANSMISSION DEVICE, SIGNAL TRANSMISSION METHOD, SIGNAL RECEPTION DEVICE, SIGNAL RECEPTION METHOD, AND PROGRAM

(71) Applicant: SONY GROUP CORPORATION, TOKYO (JP)

(72) Inventor: KAZUSHIGE TAKAHASHI, TOKYO (JP)

(21) Appl. No.: 18/842,117

(22) PCT Filed: Feb. 21, 2023
(86) PCT No.: PCT/JP2023/006125

§ 371 Date: Aug. 28, 2024

(30) Foreign Application Priority Data
Mar. 7, 2022 (JP) 2022-034670

(51) Int. Cl. H04N 21/236; H04N 7/084; H04N 21/2368

(52) U.S. Cl. CPC H04N 21/23602; H04N 7/084; H04N 21/2368

(57) ABSTRACT

The present disclosure relates to a signal transmission device, a signal transmission method, a signal reception device, a signal reception method, and a program capable of multiplexing an audio signal of a larger number of channels. Provided is a signal transmission device including a multiplexing unit that converts data of at least one frame of a MADI signal conforming to the MADI standard into an ancillary data format and multiplexes the data as words transmittable within a horizontal blanking period of a video signal conforming to a predetermined standard. The present disclosure can be applied to, for example, an imaging device such as a camera.

### TECHNICAL FIELD

The present disclosure relates to a signal transmission device, a signal transmission method, a signal reception device, a signal reception method, and a program, and more particularly, to a signal transmission device, a signal transmission method, a signal reception device, a signal reception method, and a program capable of multiplexing an audio signal of a larger number of channels.

### BACKGROUND ART

A method of transmitting an audio signal in synchronization with a high-definition video signal is known (see, for example, Patent Document 1). The Society of Motion Picture and Television Engineers (SMPTE) standard 299 formulated by the SMPTE defines a method of multiplexing an audio signal into a High-Definition Serial Digital Interface (HD-SDI) signal conforming to the HD-SDI standard.

### CITATION LIST

### Patent Document

Patent Document 1: Japanese Patent Application Laid-Open No. 2010-103776

### SUMMARY OF THE INVENTION

### Problems to be Solved by the Invention

The method of multiplexing an audio signal into an HD-SDI signal is defined in the SMPTE standard 299, but the number of channels is up to 16, and the method is not compatible with a case of multiplexing more channels. Therefore, proposals for multiplexing an audio signal of a larger number of channels have been demanded.

The present disclosure has been made in view of such a situation, and an object thereof is to multiplex an audio signal of a larger number of channels.

### Solutions to Problems

A signal transmission device according to one aspect of the present disclosure is a signal transmission device including a multiplexing unit that converts data of at least one frame of a MADI signal conforming to the MADI standard into an ancillary data format and multiplexes the data as words transmittable within a horizontal blanking period of a video signal conforming to a predetermined standard.

A signal transmission method and a program according to one aspect of the present disclosure are a signal transmission method and a program corresponding to the signal transmission device according to the one aspect of the present disclosure.

In the signal transmission device, the signal transmission method, and the program according to the one aspect of the present disclosure, data of at least one frame of a MADI signal conforming to the MADI standard is converted into an ancillary data format and is multiplexed as words transmittable within a horizontal blanking period of a video signal conforming to a predetermined standard.

A signal reception device according to one aspect of the present disclosure is a signal reception device including a separation unit that separates data of at least one frame of a MADI signal conforming to the MADI standard, the data being converted into an ancillary data format and multiplexed as words transmittable within a horizontal blanking period of a video signal conforming to a predetermined standard.

A signal reception method and a program according to one aspect of the present disclosure are a signal reception method and a program corresponding to the signal reception device according to the one aspect of the present disclosure.

In the signal reception device, the signal reception method, and the program according to the aspect of the present disclosure, data of at least one frame of a MADI signal conforming to the MADI standard, the data being converted into an ancillary data format and multiplexed as words transmittable within a horizontal blanking period of a video signal conforming to a predetermined standard, is separated.

Note that the signal transmission device and the signal reception device according to the one aspect of the present disclosure may be independent devices or may be internal blocks forming one device.

### BRIEF DESCRIPTION OF DRAWINGS

FIG. 1 shows a configuration example of an embodiment of a transmission system to which the present disclosure is applied.

FIG. 2 shows a configuration example of an imaging device in FIG. 1.

FIG. 3 shows a configuration example of a CCU in FIG. 1.

FIG. 4 shows a configuration example of one frame data of a MADI signal having a sampling frequency of 48 kHz and 64 channels.

FIG. 5 shows a bit configuration example of each channel of a MADI signal.

FIG. 6 shows a role of each bit of each channel of a MADI signal.

FIG. 7 shows a first example where a frame of a MADI signal is converted into an ancillary data format and is multiplexed into an HD-SDI signal.

FIG. 8 shows a bit configuration example of an ANC packet.

FIG. 9 shows a first example of a multiplexing position of a MADI signal in an HD-SDI signal.

FIG. 10 shows a second example of a multiplexing position of a MADI signal in an HD-SDI signal.

FIG. 11 shows a third example of a multiplexing position of a MADI signal in an HD-SDI signal.

FIG. 12 shows a second example where a frame of a MADI signal is converted into an ancillary data format and is multiplexed into an HD-SDI signal.

FIG. 13 shows a third example where a frame of a MADI signal is converted into an ancillary data format and is multiplexed into an HD-SDI signal.

### MODE FOR CARRYING OUT THE INVENTION

### System Configuration

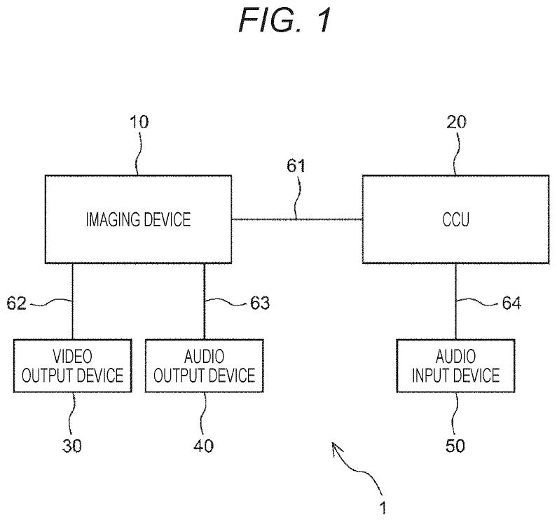

FIG. 1 shows a configuration example of an embodiment of a transmission system to which the present disclosure is applied.

As shown in FIG. 1, a transmission system 1 includes an imaging device 10, a camera control unit (CCU) 20, a video output device 30, an audio output device 40, and an audio input device 50. The imaging device 10 is an example of a signal transmission device to which the present disclosure is applied. The CCU 20 is an example of a signal reception device to which the present disclosure is applied.

The imaging device 10 and the CCU 20 are connected to each other via a transmission cable 61. The transmission cable 61 includes, for example, an optical fiber cable. The transmission cable 61 has a transmission band in which at least one or more video signals conforming to the High-Definition Serial Digital Interface (HD-SDI) standard (hereinafter, referred to as HD-SDI signals) can be multiplexed and transmitted.

The imaging device 10 images a subject and generates an imaging video signal according to the imaging result. The imaging device 10 sends (transmits) the generated imaging video signal as an HD-SDI signal to the CCU 20 via the transmission cable 61.

The video output device 30 is connected to the imaging device 10 via a transmission cable 62. The video output device 30 is a device such as an imaging device. The transmission cable 62 includes, for example, an optical fiber cable. The video output device 30 outputs a sub-video signal as an HD-SDI signal to the imaging device 10 via the transmission cable 62.

The audio output device 40 is connected to the imaging device 10 via a transmission cable 63. The audio output device 40 is an audio device that outputs a signal conforming to the Multichannel Audio Digital Interface (MADI) standard (hereinafter, referred to as a MADI signal). The MADI standard is defined in the Audio Engineering Society (AES) 10 by the AES or the like. The transmission cable 63 includes, for example, a 75 ohm coaxial cable or an optical fiber cable. The audio output device 40 supplies, for example, a 125-Mbps MADI signal to the imaging device 10 via the transmission cable 63.

The imaging device 10 can multiplex the generated imaging video signal and the sub-video signal from the video output device 30 in one transmission cable 61 and send the multiplexed signal to the CCU 20. Further, the imaging device 10 can multiplex the MADI signal from the audio output device 40 into the imaging video signal or the sub-video signal transmitted as an HD-SDI signal and send the multiplexed signal to the CCU 20.

The CCU 20 controls the imaging device 10 via the transmission cable 61. Further, the CCU 20 receives a video signal into which at least one or more HD-SDI signals are multiplexed from the imaging device 10 via the transmission cable 61. The CCU 20 can separate and output an imaging video signal, a sub-video signal, and a MADI signal multiplexed into the received transmission data.

The audio input device 50 is connected to the CCU 20 via a transmission cable 64. The audio input device 50 is an audio device that receives an input of a MADI signal. The transmission cable 64 includes, for example, a 75 ohm coaxial cable or an optical fiber cable. The audio input device 50 receives a 125-Mbps MADI signal from the CCU 20 via the transmission cable 64 and separates and processes the MADI signal as a multi-channel audio signal.

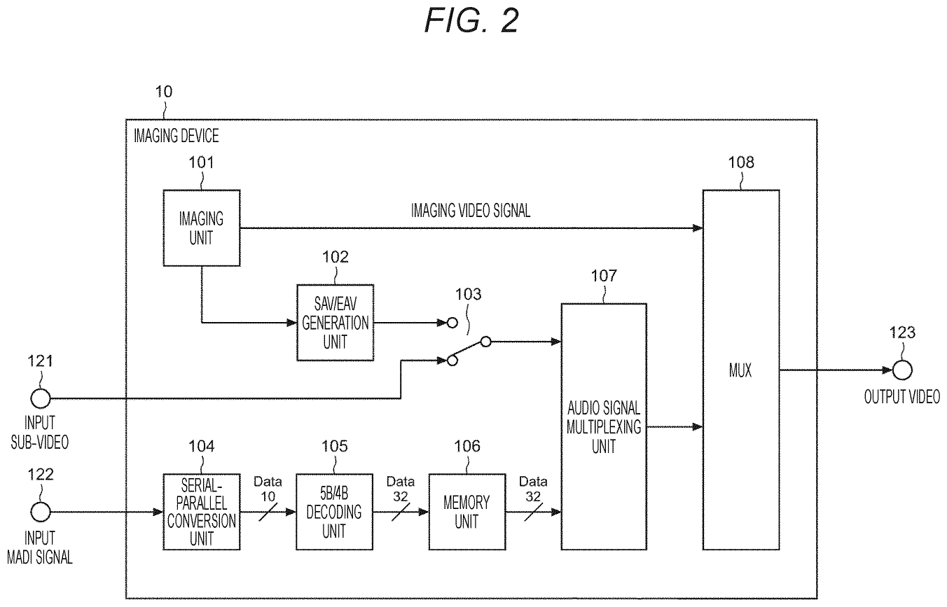

FIG. 2 shows a configuration example of the imaging device 10 in FIG. 1.

In FIG. 2, the imaging device 10 includes an imaging unit 101, an SAV/EAV generation unit 102, a switching unit 103, a serial-parallel conversion unit 104, a 5B/4B decoding unit 105, a memory unit 106, an audio signal multiplexing unit 107, and a MUX 108.

An input terminal 121 is connected to the transmission cable 62 and receives a sub-video signal output as an HD-SDI signal from the video output device 30. An input terminal 122 is connected to the transmission cable 63 and receives a MADI signal output from the audio output device 40. An output terminal 123 is connected to the transmission cable 61.

The imaging unit 101 includes an imaging element such as a charge coupled device (CCD) image sensor or a complementary metal oxide semiconductor (CMOS) image sensor and a signal processing circuit that processes an imaging signal from the imaging element. The imaging unit 101 images a subject and generates an imaging video signal according to the imaging result. The imaging unit 101 outputs the generated imaging video signal to the MUX 108. Further, the imaging unit 101 generates a timing signal in accordance with the imaging video signal to be output and outputs the generated timing signal to the SAV/EAV generation unit 102.

The SAV/EAV generation unit 102 generates start of active video (SAV) and end of active video (EAV) on the basis of the timing signal output from the imaging unit 101. The SAV indicates the start of an active video area and is a code for separating the active video area and a blanking area in a horizontal direction. The EAV indicates the end of the active video area and is a code for separating the active video area and the blanking area.

The SAV/EAV generation unit 102 generates the SAV and the EAV, and thus a signal output from the SAV/EAV generation unit 102 can be recognized as the same signal as the video signal conforming to the HD-SDI standard. The SAV/EAV generation unit 102 outputs a signal including the generated SAV and EAV (hereinafter, referred to as an SAV/EAV signal) to the switching unit 103.

The switching unit 103 is a switch that switches a signal to be output to the audio signal multiplexing unit 107 between the SAV/EAV signal output from the SAV/EAV generation unit 102 and the sub-video signal input from the input terminal 121. The switching unit 103 outputs the SAV/EAV signal or the sub-video signal to the audio signal multiplexing unit 107.

The serial-parallel conversion unit 104 converts the MADI signal input from the input terminal 122 from a 125-Mbps serial signal to a 10-bit parallel signal and outputs the converted signal to the 5B/4B decoding unit 105.

The 5B/4B decoding unit 105 decodes the signal subjected to 4B5B encoding in the audio output device 40 and restores the signal to channel data (32 bits) defined in the AES 10. The 5B/4B decoding unit 105 generates a write control signal to the memory unit 106 from the decoded signal and outputs the write control signal together with the decoded data signal to the memory unit 106.

The memory unit 106 writes the decoded data signal into a memory in accordance with the write control signal input from the 5B/4B decoding unit 105. Further, the memory unit 106 reads the data signal stored in the memory in accordance with a read control signal input from the audio signal multiplexing unit 107 and outputs the data signal to the audio signal multiplexing unit 107.

The audio signal multiplexing unit 107 multiplexes an audio signal that is the data signal input from the memory unit 106 into the SAV/EAV signal or the sub-video signal input from the switching unit 103 and outputs the multiplexed signal to the MUX 108. Further, the audio signal multiplexing unit 107 generates a read control signal for reading the data signal from the memory unit 106 and outputs the read control signal to the memory unit 106.

The MUX 108 is a multiplexer that multiplexes the imaging video signal input from the imaging unit 101 and the signal input from the audio signal multiplexing unit 107 in order to send the signals to the CCU 20 via one transmission cable 61. The signal multiplexed by the MUX 108 is sent to the CCU 20 via the transmission cable 61 connected to the output terminal 123.

In the following description, there will be described an example where, in the imaging device 10, the audio signal multiplexing unit 107 multiplexes the MADI signal input from the audio output device 40 into the sub-video signal input as an HD-SDI signal from the video output device 30 and transmits the multiplexed signal.

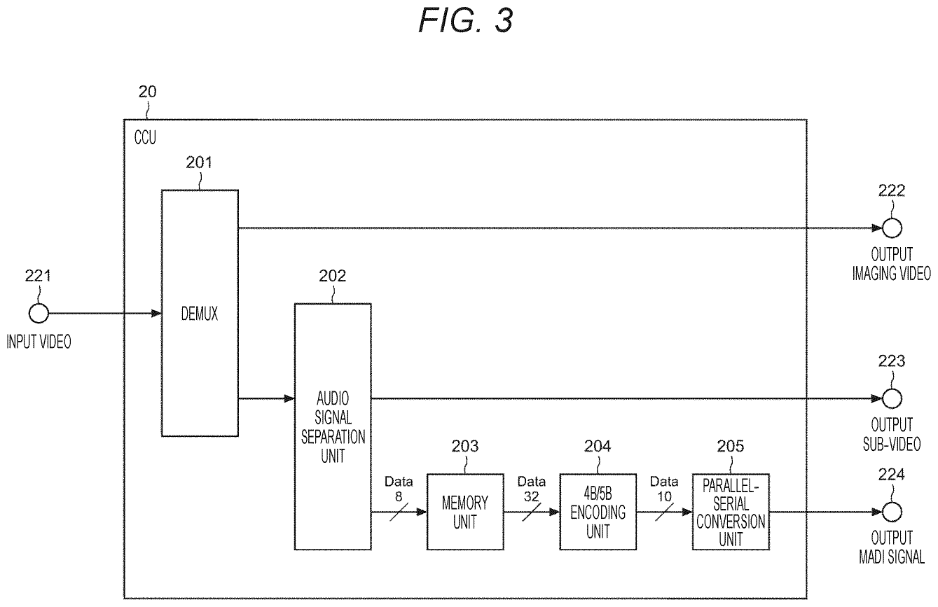

FIG. 3 shows a configuration example of the CCU 20 in FIG. 1.

In FIG. 3, the CCU 20 includes a DEMUX 201, an audio signal separation unit 202, a memory unit 203, a 4B/5B encoding unit 204, and a parallel-serial conversion unit 205.

An input terminal 221 is connected to the transmission cable 61 and receives an input of a video signal into which at least one or more HD-SDI signals are multiplexed, the video signal being output from the imaging device 10. An output terminal 222 is connected to a device (not shown) to which an imaging video signal is input via a transmission cable. An output terminal 223 is connected to a device (not shown) to which a sub-video signal is input via a transmission cable. An output terminal 224 is connected to the transmission cable 64.

The DEMUX 201 is a demultiplexer that separates and outputs the multiplexed HD-SDI signal transmitted from the imaging device 10 via the transmission cable 61. The DEMUX 201 separates a video signal input as an HD-SDI signal from the input terminal 221 into an imaging video signal and a sub-video signal into which a MADI signal is multiplexed. The DEMUX 201 outputs the imaging video signal to the output terminal 222 and outputs the sub-video signal into which the MADI signal is multiplexed to the audio signal separation unit 202.

The audio signal separation unit 202 separates the signal input from the DEMUX 201 into the sub-video signal and an audio signal included in the MADI signal. The audio signal separation unit 202 outputs the separated sub-video signal to the output terminal 223. Further, the audio signal separation unit 202 generates a write control signal to the memory unit 203 from a data packet of the separated audio signal and outputs the write control signal together with the audio signal to the memory unit 203.

The memory unit 203 writes the audio signal as a data signal into a memory in accordance with the write control signal input from the audio signal separation unit 202. The memory unit 203 reads the data signal stored in the memory in accordance with a read control signal input from the 4B/5B encoding unit 204 and outputs the data signal to the 4B/5B encoding unit 204.

In accordance with the definition of the AES 10, the 4B/5B encoding unit 204 divides channel data (32 bits) by 4 bits into 8 words, encodes each 4 bits into 5 bits, and outputs the encoded data to the parallel-serial conversion unit 205. Further, the 4B/5B encoding unit 204 generates a read control signal for reading the data signal from the memory unit 203 and outputs the read control signal to the memory unit 203.

The parallel-serial conversion unit 205 converts a parallel signal input from the 4B/5B encoding unit 204 (parallel signal subjected to 4B/5B encoding) into a 1-bit serial signal and outputs the serial signal as a 125-Mbps MADI signal to the audio input device 50 via the transmission cable 64 connected to the output terminal 224.

The transmission system 1 in FIG. 1 is used, for example, in a video production site, and a video signal and an audio signal from the imaging device 10 are transmitted to the CCU 20. The video output device 30 is a device such as an imaging device, and a sub-video signal is output to the imaging device 10 and is then transmitted to the CCU 20. The audio output device 40 is a device such as a microphone attached to the imaging device 10, and a MADI signal including a collected audio signal is output to the imaging device 10 and is then transmitted to the CCU 20.

### Method of Multiplexing MADI Signal Into HD-SDI Signal

Next, a method of multiplexing a MADI signal into an HD-SDI signal will be described.

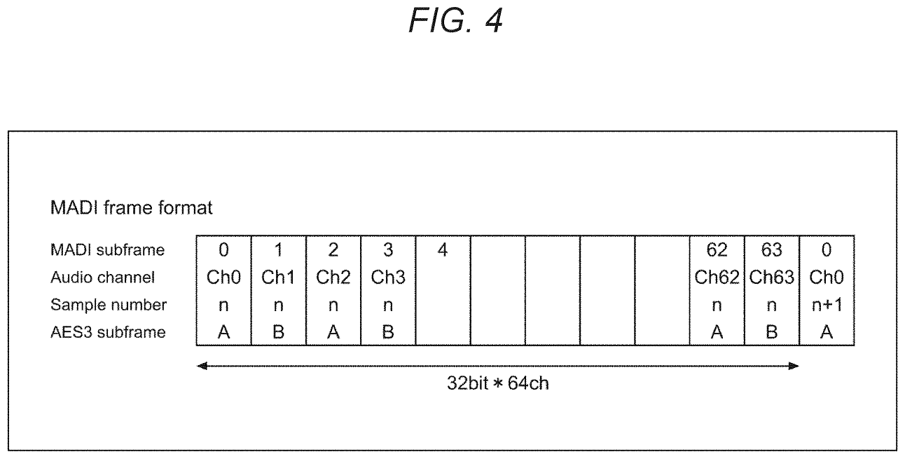

FIG. 4 shows a configuration example of one frame data of a MADI signal. FIG. 4 shows a case where an audio signal having a sampling frequency of 48 kHz and the number of channels of 64 channels is included in the MADI signal.

As shown in FIG. 4, a frame (MADI frame) of the MADI signal includes a plurality of subframes (MADI subframes). The subframes correspond to channels (audio channels), and one frame of the MADI signal includes 64 channels, each of which includes 32 bits.

In one frame of the MADI signal, the same sample number is set. In FIG. 4, a frame of a sample number n+1 continues after a frame of a sample number n. In each channel, an identification signal of a subframe A or a subframe B is set as a subframe (AES3 subframe) defined in the AES3 standard. The AES3 standard is standardized by the AES or the like.

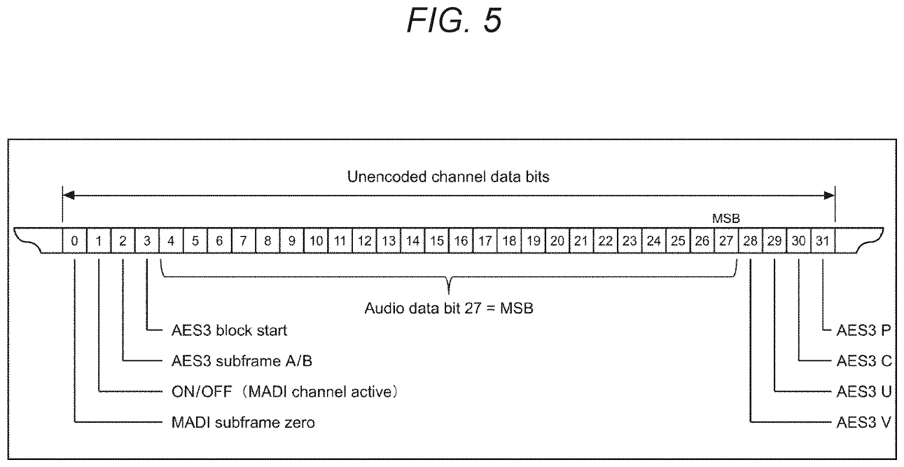

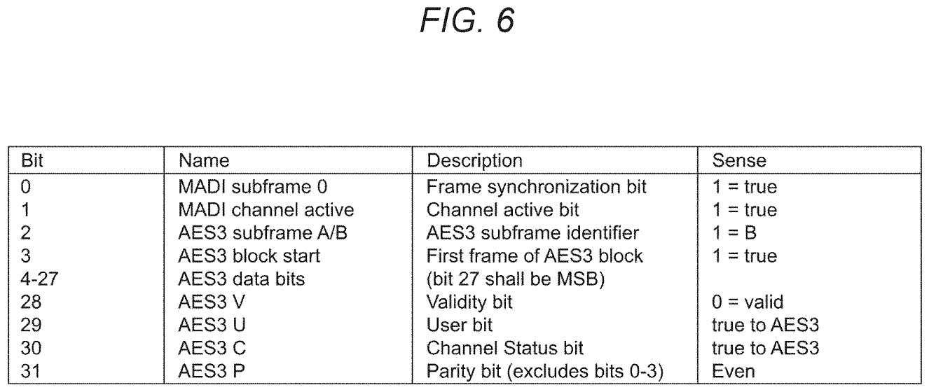

FIG. 5 shows a bit configuration example of each channel of the MADI signal. FIG. 6 shows a role of each bit, and the role will be described with reference to FIG. 6 as appropriate. As shown in FIG. 5, each channel of the MADI signal includes 32 bits of bits 0 to 31.

The bit 0 becomes “1” when the subframe number is 0 and is used for frame synchronization. The bit 1 indicates whether or not an audio signal of the channel is active and is “1” in a case where the audio signal is active. The bit 2 is an identification signal of the subframe A and the subframe B defined in the AES3 standard and is “1” in a case of the subframe B.

The bit 3 means the start of a block including 192 subframes defined in the AES3 standard and indicates a head frame of the block when the bit is “1”. The bits 4 to 27 stores 24-bit audio data. The bit 27 is a most significant bit (MSB).

The bit 28 is a validity bit defined in the AES3 standard and is “0” in a case where audio data is correct and is “1” in a case where the audio data is wrong. The bit 29 is a user bit defined in the AES3 standard and can be arbitrarily used by a user. The bit 30 is a channel status bit defined in the AES3 standard and conforms to the definition of the AES3 standard. The bit 31 is a parity bit and is set such that the number of “0” and “1” from the bit 4 to the bit 31 is an even number (even parity).

In the imaging device 10, 32 bits of each channel of the MADI signal can be divided by 8 bits into 4 words and be transmitted as data of 8 bits×256 words in an ancillary data format of the HD-SDI defined in the SMPTE standard 291.

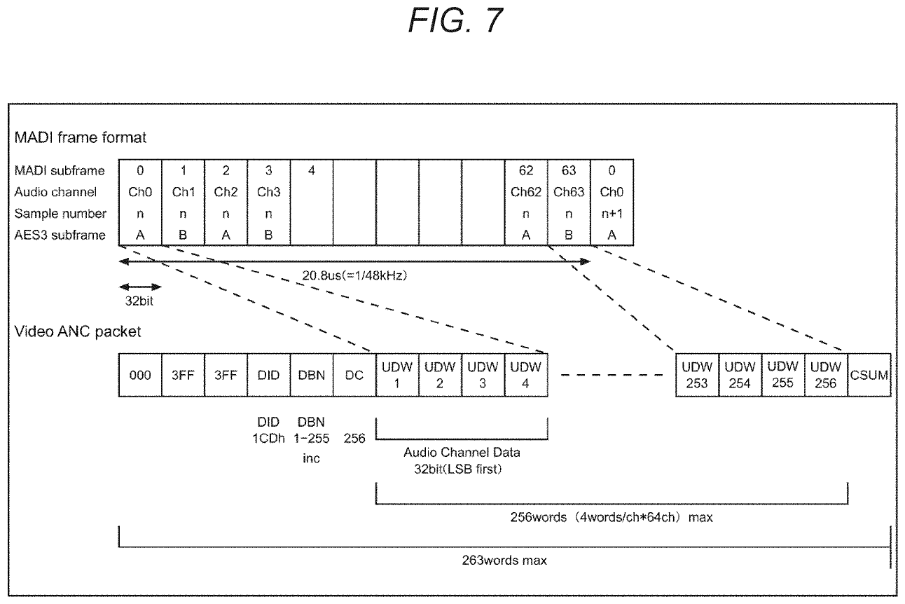

FIG. 7 shows an example where the frame of the MADI signal is converted into the ancillary data format and is multiplexed into an HD-SDI signal. FIG. 7 shows a configuration in units of words (10 bits) as an ancillary packet (ANC packet) to be multiplexed into the HD-SDI signal.

As shown in FIG. 7, in the ANC packet, a header area includes header words “000”, “3FF”, and “3FF”, a data identifier (DID) indicating the type of packet, a data block number (DBN) indicating continuity of data, and a data count (DC) indicating the number of pieces of data to be transmitted. The ANC packet stores data of each channel of the frame of the MADI signal in user data words (UDWs), each of which includes 10 bits. Following the user data words (UDWs), a checksum (CSUM) for error checking is added.

In FIG. 7, 32 bits of each channel of one frame of the MADI signal are divided by 8 bits into 4 words and are stored in UDWs 1 to 256 as data of 8 bits×256 words (4 words/ch×64 ch). Specifically, 32 bits of a channel 0 are divided by 8 bits into 4 words and are stored in the UDWs 1 to 4, respectively. Description regarding channels 1 to 62 is redundant and thus will be omitted, and 32 bits of a channel 63 are divided by 8 bits into 4 words and are stored in the UDWs 253 to 256, respectively.

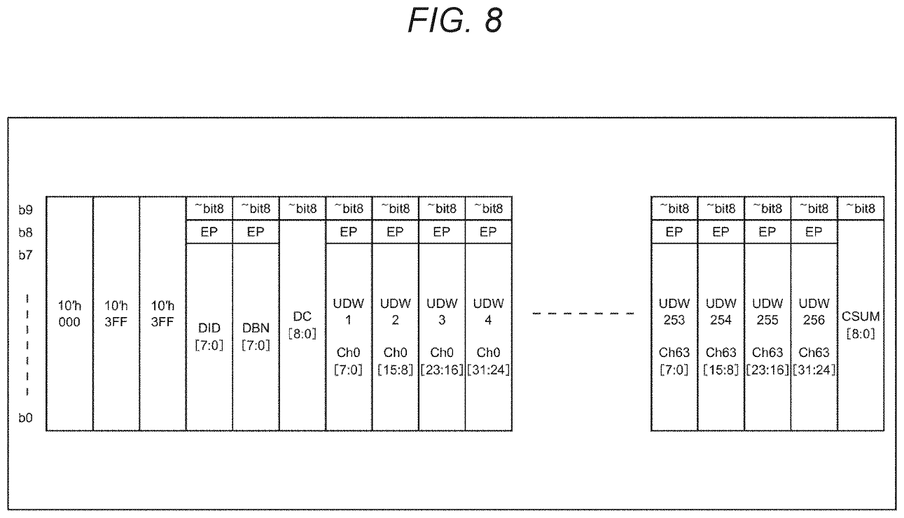

FIG. 8 shows a bit configuration example of the ANC packet. FIG. 8 shows allocation of 10 bits in one word. As shown in FIG. 8, 8-bit data, which is obtained by dividing 32 bits of each channel of one frame of the MADI signal into 4 words, is arranged in lower 8 bits (bits 0 to 7) out of the 10 bits. An even parity (EP) of the lower 8 bits is arranged in the bit 8, and inversion of the bit 8 is arranged in the bit 9.

As described above, a MADI signal including an audio signal having the sampling frequency of 48 kHz and the number of channels of 64 channels can be converted into an ANC packet of 263 words including 6 words of the header area, 256 words of the UDWs 1 to 256, and 1 word of the checksum and be multiplexed into a video signal such as a sub-video signal transmitted as an HD-SDI signal. Because the frame of the MADI signal is converted into the ancillary data format, it is possible to perform error checking using the checksum and confirm continuity using the DBN.

### Multiplexing Position of MADI Signal

Next, a multiplexing position of a MADI signal in an HD-SDI signal will be described. When data of one frame of a MADI signal is stored in an ANC packet, the MADI signal is multiplexed in the ancillary data format in a horizontal blanking period of a video signal such as a sub-video signal transmitted as an HD-SDI signal.

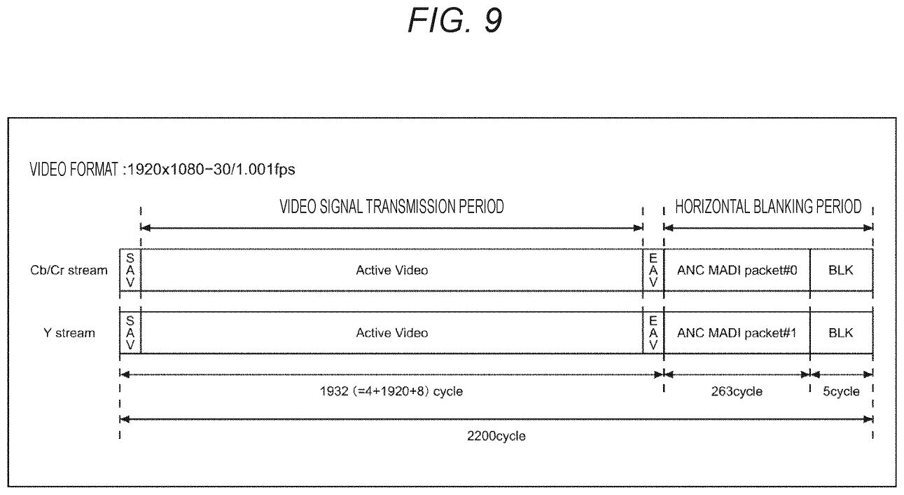

FIG. 9 shows a multiplexing position of the MADI signal when the HD-SDI signal adopts a video format in which the number of pixels in one frame (the number of effective pixels: the number of pixels in the horizontal direction x the number of lines in a vertical direction) is 1920×1080 and a frame rate is 29.97 (30/1.001) fps. This video format adopts “YCbCr 4:2:2” as a sub-sampling method and shows streams (Cb/Cr stream and Y stream) of a chrominance signal (Cb/Cr signal) and a luminance signal (Y signal) in FIG. 9.

As shown in FIG. 9, in each of the Cb/Cr and Y signals, an active video area (Active Video) specified by the SAV and the EAV is defined as a video signal transmission period for transmitting a video signal, and the remaining period is defined as a horizontal blanking period.

In FIG. 9, in a case where the frame rate at which the horizontal blanking period of the HD-SDI signal is the shortest is 29.97 fps, the total number of cycles is 2200, and a period including the SAV, the EAV, and the video signal transmission period is 1932 cycles. Thus, 268 cycles are the horizontal blanking period. Therefore, it is possible to multiplex 256 words of one frame of the MADI signal into the ANC packet in the ancillary data format in the horizontal blanking period of each of the Cb/Cr and Y signals.

That is, as shown in FIG. 7, the ANC packet includes 263 words in total when the words of the header area and the like are added to 256 words of the MADI signal. Further, as shown in FIG. 9, the horizontal blanking period of the HD-SDI signal is 268 cycles. Therefore, it is possible to transmit 263 words of the ANC packet in 263 cycles out of the 268 cycles in the horizontal blanking period of the HD-SDI signal. In the horizontal blanking period of the HD-SDI signal, a period (BLK) after the end of multiplexing of the ANC packet is 5 cycles.

In FIG. 9, the ANC packet is multiplexed in the horizontal blanking period of each of the Cb/Cr and Y signals. Specifically, an ANC packet #0 (ANC MADI packet #0) is multiplexed in the horizontal blanking period of the Cb/Cr signal, and an ANC packet #1 (ANC MADI packet #1) is multiplexed in the horizontal blanking period of the Y signal. For example, the ANC packet #1 stores a frame next to a frame of a MADI signal stored in the ANC packet #0.

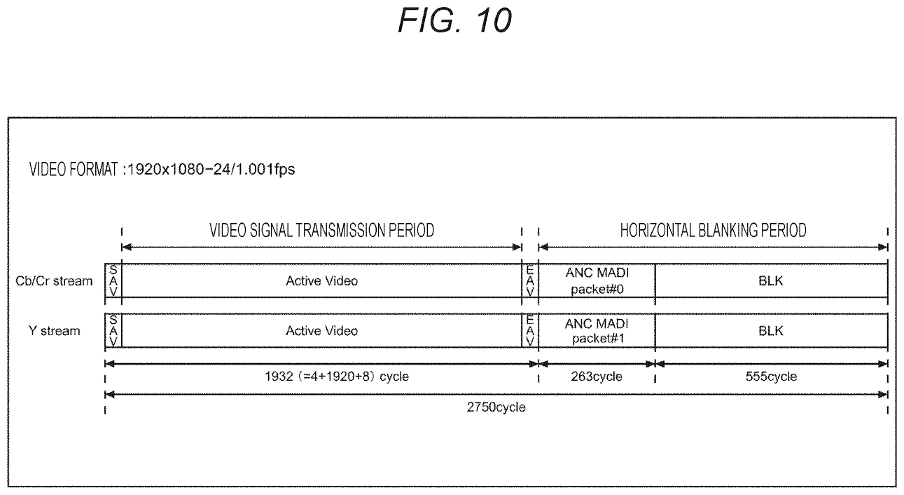

FIG. 10 shows a multiplexing position of the MADI signal when the HD-SDI signal adopts a video format in which the number of pixels in one frame is 1920×1080 and the frame rate is 23.976 (24/1.001) fps. FIG. 10, as well as FIG. 9, shows streams of Cb/Cr and Y signals.

In FIG. 10, in a case where the frame rate at which the horizontal blanking period of the HD-SDI signal is the longest is 23.976 fps, the multiplexing position of the ANC packet is the same as that in the case of FIG. 9 in which the frame rate is 29.97 fps, and 263 words of the ANC packet are transmitted in 263 cycles in the horizontal blanking period. Meanwhile, in FIG. 10, in the horizontal blanking period of the HD-SDI signal, the period (BLK) after the end of multiplexing of the ANC packet is 555 cycles, which is longer than 5 cycles in the case of FIG. 9 in which the frame rate is 29.97 fps.

As shown in FIGS. 9 and 10, when the frame rate is changed from 29.97 fps to 23.976 fps, the length of the video signal transmission period is not changed, but the horizontal blanking period is increased. Further, the number of words of the ANC packet (ANC MADI packet) to be multiplexed in the horizontal blanking period is not changed and is transmitted in 263 cycles.

Here, assuming that 8 bits out of the 10 bits of each of the Cb/Cr and Y signals are used, 256 words are transmitted for each line, and there are two lines in which a switching point defined in the SMPTE standard 299 and a payload ID defined in the SMPTE 352 standard are multiplexed, the transmission band is calculated by the following Equation (1) at the lowest frame rate of 23.976 fps.

$$8 [ bit ] * 2 * 256 [ Words ] * ( 1125 - 2 ) [ line ] * 23.976 [ fps ] = 110.285 [ Mbps ] \qquad ( 1 )$$

Note that, in Equation (1), “*” represents multiplication, and “2” multiplied by 8 [bit] means two signals of the Cb/Cr signal and the Y signal. Further, 1125 lines mean the total number of lines in the vertical direction, and 2 lines to be subtracted correspond to 2 lines of the switching point and the payload ID. Note that, among 1125 lines that are the total number of lines, 1080 lines are the number of effective lines.

An effective transmission band of the MADI signal is 4/5 of a transmission rate because of the 4B5B conversion and thus is calculated by the following Equation (2). Note that a 125-Mbps MADI signal is input to the imaging device 10 from the audio output device 40.

$$125 [ Mbps ] * 4 / 5 = 100 [ Mbps ] \qquad ( 2 )$$

100 [Mbps] calculated by Equation (2) is smaller than 110.285 [Mbps] calculated by Equation (1). That is, the effective transmission band of the MADI signal falls within the transmission band in a case where the horizontal blanking period having the frame rate of 23.976 fps is used. Therefore, it is possible to transmit the MADI signal by using only the horizontal blanking period of the HD-SDI signal by the above transmission method.

As described above, the data of one frame of the MADI signal is converted into the ancillary data format and is multiplexed in the horizontal blanking period of each of the Cb/Cr and Y signals, and thus it is possible to transmit two frames of MADI signals and to transmit the MADI signals within the horizontal blanking period. Note that the present disclosure is not limited to the video formats shown in FIGS. 9 and 10, and, for example, may be applied to another video format such as a video format (2640 cycles) in which the number of pixels of one frame is 1920×1080 and the frame rate is 25 fps. Further, in FIGS. 9 and 10, the stream of the Cb/Cr signal and the stream of the Y signal are vertically arranged for convenience of description, but actually, the Cb/Cr signal and the Y signal are not transmitted in parallel but are transmitted in serial.

As described above, in the transmission system 1, the HD-SDI signal into which the MADI signal is multiplexed is transmitted via the transmission cable 61 by performing the following processing between the imaging device 10 and the CCU 20. That is, in the imaging device 10, the audio signal multiplexing unit 107 converts data of at least one frame of the MADI signal into the ancillary data format and multiplexes the converted data as words transmittable within the horizontal blanking period of the HD-SDI signal. Meanwhile, in the CCU 20, the audio signal separation unit 202 separates the data of at least one frame of the MADI signal converted into the ancillary data format and multiplexed as words transmittable within the horizontal blanking period of the HD-SDI signal.

Therefore, the MADI signal including the audio signal having the sampling frequency of 48 kHz and the number of channels of 64 channels can be multiplexed by using the horizontal blanking period of the HD-SDI signal. Accordingly, it is also possible to compatible with the number of channels exceeding a maximum of 16 channels defined in the SMPTE standard 299, and, when the audio signal is multiplexed into the HD-SDI signal, it is possible to multiplex an audio signal of a larger number of channels.

### Modifications

### Other Examples of Video Signal

In the above description, the case where a MADI signal is multiplexed into a sub-video signal input from the video output device 30 has been exemplified, but the MADI signal may be multiplexed into another video signal such as an imaging video signal generated by the imaging device 10. In a case where the MADI signal is multiplexed into the imaging video signal generated by the imaging device 10, the video output device 30 does not need to be provided in the transmission system 1 of FIG. 1.

Further, in the above description, the case where a MADI signal is multiplexed into an HD-SDI signal has been exemplified, but the MADI signal is not limited to being multiplexed into the HD-SDI signal and can be multiplexed into a video signal conforming to a predetermined standard. For example, the MADI signal can be similarly multiplexed into a 3G-SDI signal conforming to the 3G-SDI standard, a 6G-SDI signal conforming to the 6G-SDI standard, or a 12G-SDI signal conforming to the 12G-SDI standard.

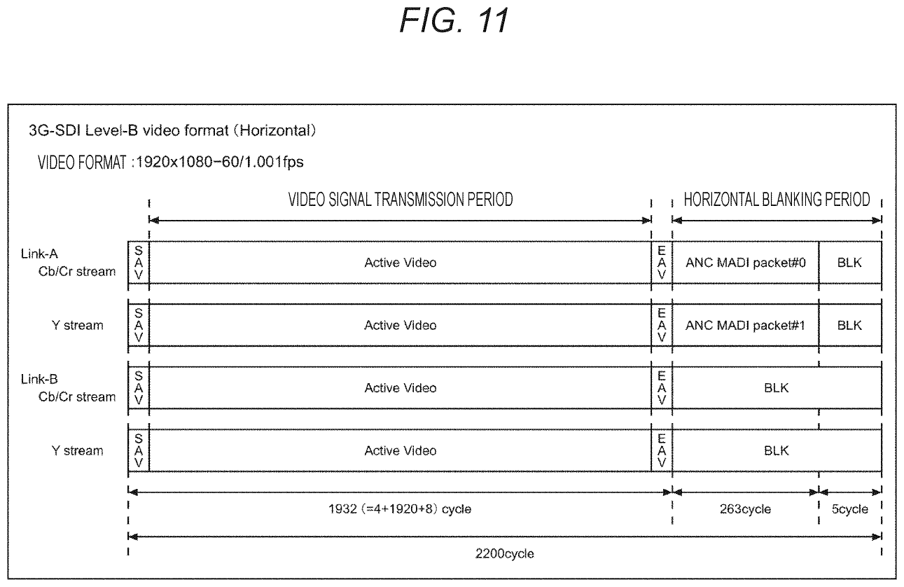

FIG. 11 shows a multiplexing position of the MADI signal when the 3G-SDI signal adopts a video format in which the number of pixels in one frame is 1920×1080 and a frame rate is 59.94 (60/1.001) fps. As shown in FIG. 11, in the 3G-SDI signal conforming to the 3G-SDI level B, the streams of the Cb/Cr and Y signals are transmitted in each of links A (Link-A) and B (Link-B).

As shown in FIG. 11, it is possible to multiplex an ANC packet in the horizontal blanking period of each of the Cb/Cr and Y signals of the link A between the link A and the link B. The multiplexing position of the ANC packet is the same as that in the case of FIG. 9 in which the frame rate is 29.97 fps, and 263 words of the ANC packet are transmitted in 263 cycles in the horizontal blanking period. Further, the period (BLK) after the end of multiplexing of the ANC packet is similarly 5 cycles.

Further, in addition to the link A, the horizontal blanking period of each of the Cb/Cr and Y signals of the link B may be used. By using the horizontal blanking period of each of the Cb/Cr and Y signals of the links A and B, twice the amount of data can be transmitted as compared with a case where only the link A is used. For example, in a case where only the link A is used, it is possible to transmit a MADI signal including an audio signal having the sampling frequency of 48 kHz and 64 channels. However, by using the link A and the link B, it is possible to transmit a MADI signal including an audio signal having the sampling frequency of 48 kHz and 128 channels.

Note that, in the above description, the case where “YCbCr 4:2:2” is adopted as the sub-sampling method has been exemplified. However, for example, another method such as “YCbCr 4:4:4” may be adopted.

### Other Examples of Sampling Frequency and Number of Channels

In the above description, a MADI signal including an audio signal having the sampling frequency of 48 kHz and the number of channels of 64 channels has been exemplified. However, the sampling frequency and the number of channels are not limited thereto. For example, the sampling frequency may be 48 kHz and the number of channels may be 56 channels, or the sampling frequency may be 96 kHz and the number of channels may be 32 channels.

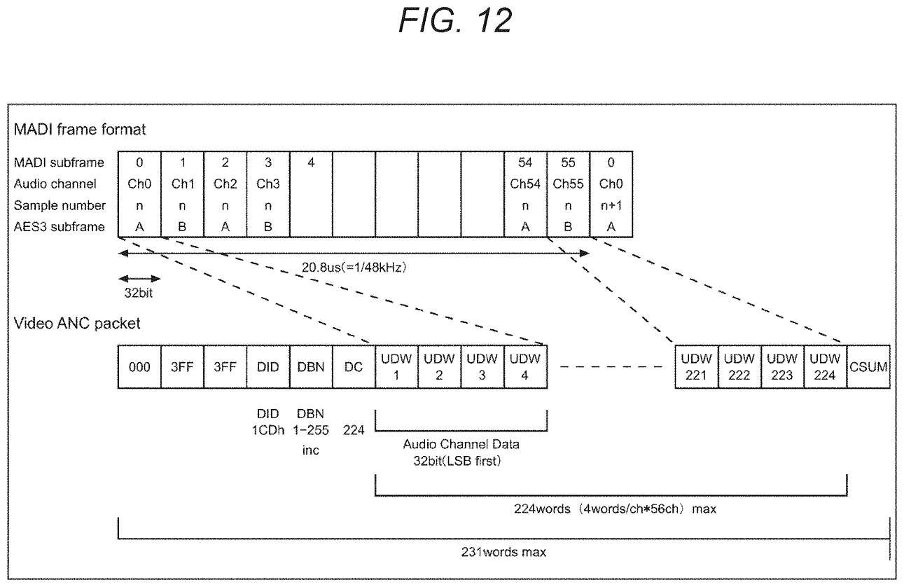

More specifically, in a case where a frame of a MADI signal including an audio signal having the sampling frequency of 48 kHz and the number of channels of 56 channels is converted into the ancillary data format and is multiplexed into an HD-SDI signal, the MADI signal is as shown in FIG. 12. In FIG. 12, 32 bits of each channel of one frame of the MADI signal are divided by 8 bits into 4 words and are stored in UDWs 1 to 224 of an ANC packet as data of 8 bits×224 words (4 words/ch×56 ch).

As described above, the MADI signal including the audio signal having the sampling frequency of 48 kHz and the number of channels of 56 channels can be converted into the ANC packet of 231 words including 6 words of a header area, 224 words of the UDWs 1 to 224, and 1 word of a checksum. Then, as described with reference to FIG. 9 and the like, it is possible to multiplex and transmit the ANC packet of 231 words in the horizontal blanking period of each of the Cb/Cr and Y signals included in the HD-SDI signal.

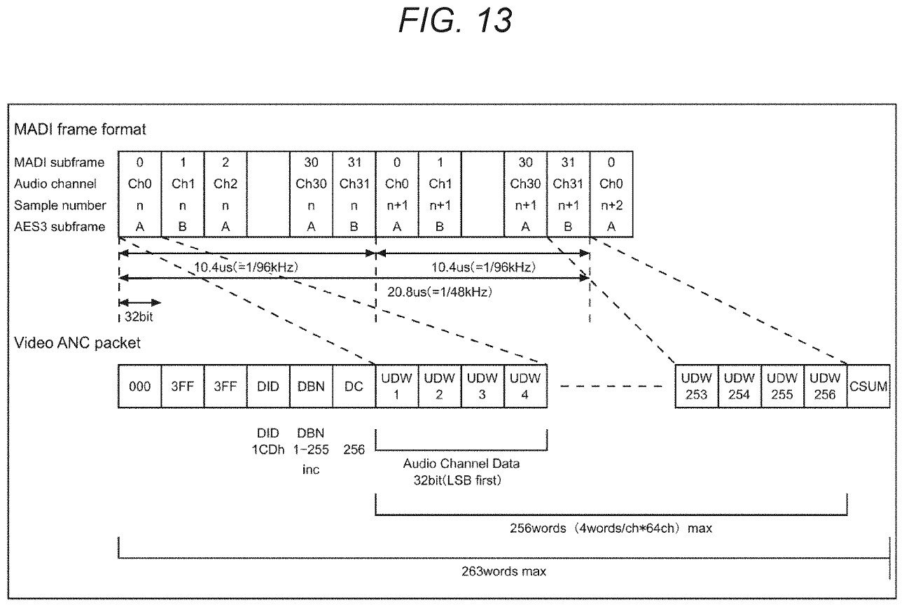

Further, in a case where a frame of a MADI signal including an audio signal having the sampling frequency of 96 kHz and the number of channels of 32 channels is converted into the ancillary data format and is multiplexed into an HD-SDI signal, the MADI signal is as shown in FIG. 13. In FIG. 13, 32 bits of each of the 32 channels of one frame of the MADI signal are divided by 8 bits into 4 words, and data of two frames of MADI signals is stored in UDWs 1 to 256 of an ANC packet as data of 8 bits×256 words (4 words/ch×64 ch (32 ch×2)).

As described above, the MADI signal including the audio signal having the sampling frequency of 96 kHz and the number of channels of 32 channels can be converted into the ANC packet of 263 words including 6 words of a header area, 256 words of the UDWs 1 to 256, and 1 word of a checksum. Then, as described with reference to FIG. 9 and the like, it is possible to multiplex and transmit the ANC packet of 263 words in the horizontal blanking period of each of the Cb/Cr and Y signals included in the HD-SDI signal.

### Other Configurations of System

In the transmission system 1 of FIG. 1, the audio output device 40 is connected to the imaging device 10, and the audio input device 50 is connected to the CCU 20. However, other configurations may be adopted. For example, in a case where the audio output device 40 and the audio input device 50 are not provided, and a multi-channel audio signal of more than 16 channels is processed in the imaging device 10, it is possible to convert a multi-channel audio signal into a format of a MADI signal in the imaging device 10 and transmit the converted signal to the CCU 20. In this case, the CCU 20 may reconvert the format of the MADI signal transmitted from the imaging device 10 into a 24-bit digital audio signal and process the reconverted signal as a multi-channel audio signal.

In the above description, the case where a MADI signal is multiplexed when an HD-SDI signal is transmitted from the imaging device 10 to the CCU 20 has been described. However, the MADI signal may be multiplexed by applying the technology according to the present disclosure when a return signal is transmitted from the CCU 20 to the imaging device 10. Further, the technology according to the present disclosure can also be applied to a device having input/output of an HD-SDI signal, such as a switcher or a recorder connected to the CCU 20.

Note that, in the imaging device 10 of FIG. 2, for example, when data is transmitted in a case where no sub-video signal is input to the input terminal 121, the multiplexing position of the MADI signal may be set to the video signal transmission period of the HD-SDI signal. At this time, although a video signal cannot be transmitted, an audio signal of more channels can be multiplexed, or not only the MADI signal multiplexed in the video signal transmission period, but also other piece of data in the ancillary data format can be multiplexed in the horizontal blanking period.

### Computer Configuration

The processing (the series of processing described above) executed by the imaging device 10 and the CCU 20 can be executed by hardware or software. In a case where the series of processing is executed by software, a program configuring the software is installed on a computer.

In the computer, a central processing unit (CPU) loads a program recorded in a storage device such as a read only memory (ROM), a hard disk, or a non-volatile memory into a random access memory (RAM) and executes the program, and thus the series of processing described above is performed.

The program executed by the computer (CPU) can be provided by being recorded on a removable recording medium as a package medium, for example. Further, the program can be provided via a wired or wireless transmission medium such as a local area network, the Internet, or digital satellite broadcasting.

In the computer, the program can be installed in the storage device by attaching the removable recording medium to a drive. The drive drives the removable recording medium such as a semiconductor memory, an optical disk, a magneto-optical disk, or a magnetic disk. Further, the program can be received by a communication device such as a network interface via a wired or wireless transmission medium and be installed in the storage device. In addition, the program can be preinstalled in the ROM or the storage device.

Note that embodiments of the present disclosure are not limited to the embodiment described above, and various modifications may be made without departing from the scope of the present disclosure. Further, the effects described herein are merely examples and are not limited to specific effects, and some other effects may be provided. In the present specification, a system refers to a logical assembly of a plurality of devices.

Further, the present disclosure can have the following configurations.
(1)

A signal transmission device including
a multiplexing unit that converts data of at least one frame of a MADI signal conforming to the Multichannel Audio Digital Interface (MADI) standard into an ancillary data format and multiplexes the data as words transmittable within a horizontal blanking period of a video signal conforming to a predetermined standard.
(2)

The signal transmission device according to (1), in which
the predetermined standard is the High-Definition Serial Digital Interface (HD-SDI) standard.
(3)

The signal transmission device according to (1) or (2), in which
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of one frame of the MADI signal in the ancillary data format in the horizontal blanking period of each of the Cb/Cr and Y signals.
(4)

The signal transmission device according to (1) or (2), in which
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 23.976 fps,
a Cb/Cr signal and a Y signal included in the video signal each can transmit 818 words within the horizontal blanking period, and
the multiplexing unit multiplexes the data of one frame of the MADI signal in the ancillary data format in the horizontal blanking period of each of the Cb/Cr and Y signals.
(5)

The signal transmission device according to (1) or (2), in which
the MADI signal includes an audio signal having a sampling frequency of 48 kHz and 56 channels,
the data of one frame of the MADI signal in the ancillary data format is 231 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of one frame of the MADI signal in the ancillary data format in the horizontal blanking period of each of the Cb/Cr and Y signals.
(6)

The signal transmission device according to (1) or (2), in which
the MADI signal includes an audio signal having a sampling frequency of 96 kHz and 32 channels,
the data of two frames of the MADI signals in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of two frames of the MADI signals in the ancillary data format in the horizontal blanking period of the Cb/Cr signal or Y signal.
(7)

The signal transmission device according to (1), in which
the predetermined standard is the 3G-SDI standard, the 6G-SDI standard, or the 12G-SDI standard.
(8)

The signal transmission device according to (1) or (7), in which
the MADI signal includes an audio signal having a sampling frequency of 48 kHz and 64 channels,
the data of one frame of the MADI signal in the ancillary data format is 263 words,
the video signal conforms to the 3G-SDI standard and adopts a format in which the number of pixels of one frame is 1920×1080 and a frame rate is 59.94 fps,
a Cb/Cr signal and a Y signal of links A and B included in the video signal each can transmit 268 words within the horizontal blanking period, and
the multiplexing unit multiplexes the data of one frame of the MADI signal in the ancillary data format in the horizontal blanking period of each of the Cb/Cr and Y signals of the link A.
(9)

A signal transmission method, in which
a signal transmission device converts data of at least one frame of a MADI signal conforming to the MADI standard into an ancillary data format and multiplexes the data as words transmittable within a horizontal blanking period of a video signal conforming to a predetermined standard.
(10)

A program for causing a computer to function as
a multiplexing unit that converts data of at least one frame of a MADI signal conforming to the MADI standard into an ancillary data format and multiplexes the data as words transmittable within a horizontal blanking period of a video signal conforming to a predetermined standard.
(11)

A signal reception device including:
a separation unit that separates data of at least one frame of a MADI signal conforming to the MADI standard, the data being converted into an ancillary data format and multiplexed as words transmittable within a horizontal blanking period of a video signal conforming to a predetermined standard.
(12)

The signal reception device according to (11), in which
the predetermined standard is the HD-SDI standard.
(13)

The signal reception device according to (11) or (12), in which
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of one frame of the MADI signal in the ancillary data format multiplexed in the horizontal blanking period of each of the Cb/Cr and Y signals.
(14)

The signal reception device according to (11) or (12), in which
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 23.976 fps,
a Cb/Cr signal and a Y signal included in the video signal each can transmit 818 words within the horizontal blanking period, and
the separation unit separates the data of one frame of the MADI signal in the ancillary data format multiplexed in the horizontal blanking period of each of the Cb/Cr and Y signals.
(15)

The signal reception device according to (11) or (12), in which
the MADI signal includes an audio signal having a sampling frequency of 48 kHz and 56 channels,
the data of one frame of the MADI signal in the ancillary data format is 231 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of one frame of the MADI signal in the ancillary data format multiplexed in the horizontal blanking period of each of the Cb/Cr and Y signals.
(16)

The signal reception device according to (11) or (12), in which
the MADI signal includes an audio signal having a sampling frequency of 96 kHz and 32 channels,
the data of two frames of the MADI signals in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of two frames of the MADI signals in the ancillary data format multiplexed in the horizontal blanking period of the Cb/Cr signal or the Y signal.
(17)

The signal reception device according to (11), in which
the predetermined standard is the 3G-SDI standard, the 6G-SDI standard, or the 12G-SDI standard.
(18)

The signal reception device according to (11) or (17), in which
the MADI signal includes an audio signal having a sampling frequency of 48 kHz and 64 channels,
the data of one frame of the MADI signal in the ancillary data format is 263 words,
the video signal conforms to the 3G-SDI standard and adopts a format in which the number of pixels of one frame is 1920×1080 and a frame rate is 59.94 fps,
a Cb/Cr signal and a Y signal of links A and B included in the video signal each can transmit 268 words within the horizontal blanking period, and
the separation unit separates the data of one frame of the MADI signal in the ancillary data format multiplexed in the horizontal blanking period of each of the Cb/Cr and Y signals of the link A.
(19)

A signal reception method, in which
a signal reception device separates data of at least one frame of a MADI signal conforming to the MADI standard, the data being converted into an ancillary data format and multiplexed as words transmittable within a horizontal blanking period of a video signal conforming to a predetermined standard.
(20)

A program for causing a computer to function as
a separation unit that separates data of at least one frame of a MADI signal conforming to the MADI standard, the data being converted into an ancillary data format and multiplexed as words transmittable within a horizontal blanking period of a video signal conforming to a predetermined standard.

### REFERENCE SIGNS LIST

1 Transmission system
10 Imaging device
20 CCU
30 Video output device
40 Audio output device
50 Audio input device
61 Transmission cable
62 Transmission cable
63 Transmission cable
64 Transmission cable
101 Imaging unit
102 SAV/EAV generation unit
103 Switching unit
104 Serial-parallel conversion unit
105 5B/4B decoding unit
106 Memory unit
107 Audio signal multiplexing unit
108 MUX
201 DEMUX
202 Audio signal separation unit
203 Memory unit
204 4B/5B encoding unit
205 Parallel-serial conversion unit

1. A signal transmission device comprising
a multiplexing unit that converts data of at least one frame of a MADI signal conforming to the Multichannel Audio Digital Interface (MADI) standard into an ancillary data format and multiplexes the data as words transmittable within a horizontal blanking period of a video signal conforming to a predetermined standard.

2. The signal transmission device according to claim 1, wherein
the predetermined standard is the High-Definition Serial Digital Interface (HD-SDI) standard.

3. The signal transmission device according to claim 2, wherein
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of one frame of the MADI signal in the ancillary data format in the horizontal blanking period of each of the Cb/Cr and Y signals.

4. The signal transmission device according to claim 2, wherein
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 23.976 fps,
a Cb/Cr signal and a Y signal included in the video signal each can transmit 818 words within the horizontal blanking period, and
the multiplexing unit multiplexes the data of one frame of the MADI signal in the ancillary data format in the horizontal blanking period of each of the Cb/Cr and Y signals.

5. The signal transmission device according to claim 2, wherein
the MADI signal includes an audio signal having a sampling frequency of 48 kHz and 56 channels,
the data of one frame of the MADI signal in the ancillary data format is 231 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of one frame of the MADI signal in the ancillary data format in the horizontal blanking period of each of the Cb/Cr and Y signals.

6. The signal transmission device according to claim 2, wherein
the MADI signal includes an audio signal having a sampling frequency of 96 kHz and 32 channels,
the data of two frames of the MADI signals in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the multiplexing unit multiplexes the data of two frames of the MADI signals in the ancillary data format in the horizontal blanking period of the Cb/Cr signal or Y signal.

7. The signal transmission device according to claim 1, wherein
the predetermined standard is the 3G-SDI standard, the 6G-SDI standard, or the 12G-SDI standard.

8. The signal transmission device according to claim 7, wherein
the MADI signal includes an audio signal having a sampling frequency of 48 kHz and 64 channels,
the data of one frame of the MADI signal in the ancillary data format is 263 words,
the video signal conforms to the 3G-SDI standard and adopts a format in which the number of pixels of one frame is 1920×1080 and a frame rate is 59.94 fps,
a Cb/Cr signal and a Y signal of links A and B included in the video signal each can transmit 268 words within the horizontal blanking period, and
the multiplexing unit multiplexes the data of one frame of the MADI signal in the ancillary data format in the horizontal blanking period of each of the Cb/Cr and Y signals of the link A.

9. A signal transmission method, wherein
a signal transmission device converts data of at least one frame of a MADI signal conforming to the MADI standard into an ancillary data format and multiplexes the data as words transmittable within a horizontal blanking period of a video signal conforming to a predetermined standard.

10. A program for causing a computer to function as
a multiplexing unit that converts data of at least one frame of a MADI signal conforming to the MADI standard into an ancillary data format and multiplexes the data as words transmittable within a horizontal blanking period of a video signal conforming to a predetermined standard.

11. A signal reception device comprising
a separation unit that separates data of at least one frame of a MADI signal conforming to the MADI standard, the data being converted into an ancillary data format and multiplexed as words transmittable within a horizontal blanking period of a video signal conforming to a predetermined standard.

12. The signal reception device according to claim 11, wherein
the predetermined standard is the HD-SDI standard.

13. The signal reception device according to claim 12, wherein
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of one frame of the MADI signal in the ancillary data format multiplexed in the horizontal blanking period of each of the Cb/Cr and Y signals.

14. The signal reception device according to claim 12, wherein
the MADI signal includes an audio signal having a sampling frequency of 48 kHz and 64 channels,
the data of one frame of the MADI signal in the ancillary data format is 263 words,
the video signal adopts a format in which the number of pixels of one frame is 1920×1080 and a frame rate is 23.976 fps,
a Cb/Cr signal and a Y signal included in the video signal each can transmit 818 words within the horizontal blanking period, and
the separation unit separates the data of one frame of the MADI signal in the ancillary data format multiplexed in the horizontal blanking period of each of the Cb/Cr and Y signals.

15. The signal reception device according to claim 12, wherein
the MADI signal includes an audio signal having a sampling frequency of 48 kHz and 56 channels,
the data of one frame of the MADI signal in the ancillary data format is 231 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of one frame of the MADI signal in the ancillary data format multiplexed in the horizontal blanking period of each of the Cb/Cr and Y signals.

16. The signal reception device according to claim 12, wherein
the MADI signal includes an audio signal having a sampling frequency of 96 kHz and 32 channels,
the data of two frames of the MADI signals in the ancillary data format is 263 words,
the video signal adopts a format in which the number of pixels of one frame is 1920×1080 and a frame rate is 29.97 fps,
a Cb/Cr signal and a Y signal included in the video signal each can transmit 268 words within the horizontal blanking period, and
the separation unit separates the data of two frames of the MADI signals in the ancillary data format multiplexed in the horizontal blanking period of the Cb/Cr signal or the Y signal.

17. The signal reception device according to claim 11, wherein
the predetermined standard is the 3G-SDI standard, the 6G-SDI standard, or the 12G-SDI standard.

18. The signal reception device according to claim 17, wherein
the MADI signal includes an audio signal having a sampling frequency of 48 kHz and 64 channels,
the data of one frame of the MADI signal in the ancillary data format is 263 words,
the video signal conforms to the 3G-SDI standard and adopts a format in which the number of pixels of one frame is 1920×1080 and a frame rate is 59.94 fps,
a Cb/Cr signal and a Y signal of links A and B included in the video signal each can transmit 268 words within the horizontal blanking period, and
the separation unit separates the data of one frame of the MADI signal in the ancillary data format multiplexed in the horizontal blanking period of each of the Cb/Cr and Y signals of the link A.

19. A signal reception method, wherein
a signal reception device separates data of at least one frame of a MADI signal conforming to the MADI standard, the data being converted into an ancillary data format and multiplexed as words transmittable within a horizontal blanking period of a video signal conforming to a predetermined standard.

20. A program for causing a computer to function as
a separation unit that separates data of at least one frame of a MADI signal conforming to the MADI standard, the data being converted into an ancillary data format and multiplexed as words transmittable within a horizontal blanking period of a video signal conforming to a predetermined standard.
